(19) United States
(12) Patent Application Publication
(10) Pub. No.: US 2016/0231443 A1
(43) Pub. Date: Aug. 11, 2016

(54) ACOUSTIC CONVERTER, ACOUSTIC CONVERTER SYSTEM, OPTICAL HYDROPHONE, ACOUSTIC CONVERTER ARRAY AND WATERCRAFT

(71) Applicant: ATLAS ELEKTRONIK GMBH, Bremen (DE)

(72) Inventors: Thomas REIPSCHLÄGER, Bremen (DE); Stephan SCHULZE, Rahden (DE)

(73) Assignee: ATLAS ELEKTRONIK GMBH, Bremen (DE)

(21) Appl. No.: 15/022,045

(22) PCT Filed: Aug. 12, 2014
(86) PCT No.: PCT/DE2014/100290

§ 371 Date: Mar. 15, 2016

(30) Foreign Application Priority Data
Sep. 17, 2013 (DE) 10 2013 110 210.7

(51) Int. Cl. G01V 1/18; G01V 1/20; G01H 9/00

(52) U.S. Cl. CPC G01V 1/186; G01H 9/004; G01V 1/20

(57) ABSTRACT

The invention relates to an acoustic converter (101), in particular a hydrophone (103), comprising an interferometer and an associated first vibration element (151, 251), which is maintained by a support. Said interferometer comprises a light source (111), a first signal beam (113), a signal beam splitter, a first reference beam (115), a first scanning beam (117), a first measuring beam (119) and an optical sensor (141). Said light source emits the first signal beam and the first reference beam and the first measuring beam are superimposed onto the optical sensor. The first scanning beam is directed to the first vibration element and the first measuring beam causes a Doppler shift with respect to the first scanning beam based on a vibration of the first vibration element, characterized in that the first vibration element is arranged in a first liquid.

The invention concerns an acoustic converter, in particular a hydrophone, with an interferometer and an associated first vibration element, which is maintained by a support, wherein the interferometer comprises a light source, a first signal beam, a signal beam splitter, a first reference beam, a first scanning beam, a first measuring beam and an optical sensor, wherein the light source emits the first signal beam and the first reference beam and the first measuring beam are superimposed onto the optical sensor, with the first scanning beam being directed to the first vibration element and the first measuring beam causing a Doppler shift with respect to the first scanning beam based on a vibration of the first vibration element, an acoustic converter system that features an acoustic converter of that nature, an optical hydrophone, an acoustic converter array and a watercraft that features the above-mentioned components.

Optical microphones based on a laser beam that is directed onto a membrane excited by sound and evaluating the intensity of the reflection via an optical sensor are known in the art. The sound in this causes a deformation (e.g. a vibration or movement) of the membrane, which in turn causes a change/shift in intensity of the reflected light at the measuring point.

Such systems cannot be used in cases in which minimal sound intensities are to be measured, or may only be used conditionally. Furthermore, such systems cannot be used in liquid media like water since the deflections of the membrane are very small.

The sensor system described above consists of two glass fibers that have to be arranged in a certain, exact angle to one another (light output and light input). In such a design, the mechanical effort required to obtain a stable working point is considerable.

The purpose of the invention is to improve the state of the art.

The task is solved by an acoustic converter, in particular a hydrophone, with an interferometer and an associated first vibration element, which is maintained by a support, wherein the interferometer comprises a light source, a first signal beam, a signal beam splitter, a first reference beam, a first scanning beam, a first measuring beam and an optical sensor, wherein the light source emits the first signal beam and the first reference beam and the first measuring beam are superimposed onto the optical sensor, with the first scanning beam being directed to the first vibration element and the first measuring beam causing a Doppler shift with respect to the first scanning beam based on a vibration of the first vibration element, characterized in that the first vibration element is arranged in a first liquid.

Thus, a particularly sensitive microphone may be provided that can be used in liquid media. Information may be obtained both from the particle velocity and the sound pressures.

Additionally, it is thus possible to provide a completely new technology for hydrophones that does not generate electronic signals in the aqueous environment or have to be guided. It is particularly advantageous that only optical signals must be guided in water, and the processing of the signals may, for example, take place inside the submarine. This means that there is no need for any electrical power supply outboard.

Furthermore, a sound converter may be provided that has improved characteristics with regard to dynamics and sensitivity.

The following terminology is explained:

An “acoustic converter” is any device that converts a sound signal to an electrically processable quantity.

A “hydrophone” is an acoustic converter that is used in a liquid, especially water or seawater. The hydrophone allows measuring sound signals of a few Hertz [Hz=1/sec.] up to several hundred thousand Hz. Such hydrophones may especially be used for active and/or passive sonars.

An “interferometer” is a technical device serving for interferometry. It is used to determine interferences (superposition of waves, in this case light waves) for precision measurements. General fields of application are length measurements, refractive index measurements, angular measurements and spectroscopy. The present interferometer is especially a vibrometer (also referred to as laser Doppler vibrometer).

A “vibration element” generally is a component that converts the sound signal to a mechanical vibration. This mechanical vibration is then read by the interferometer (vibrometer). The mechanical vibration is proportional to the vibration of the sound signal, or a calibration is executed, thus allowing the sound signal to be determined on the basis of the measured mechanical vibration using a correction value. The vibration elements may have high light reflecting characteristics since this may serve to increase the measuring beam intensity.

The vibration element is supported or fixed by a “support”. In the event that, for example, the vibration element is a membrane, the support may stretch the membrane with a frame, for instance, or fix it immovably.

The “light source” may comprise all sources of light emitting interferable (coherent) light signals. The light source is especially a laser (light amplifier by stimulated emission of radiation).

The “first signal beam” is emitted by the light source. It is directed to an optically separating element, especially to a semipermeable mirror, which divides the first signal beam into a first reference beam and a first scanning beam.

The “first reference beam” serves to interfere with a first measuring signal.

The “first scanning beam” is the (light) beam that is directed onto the vibration element, e.g. orthogonally to its vibrating surface. Since all the beams described here may at least partially be guided in optical wave guides, the first scanning beam may be directed or focused onto the vibration element especially with decoupling optics (e.g. collecting lens) at the end of an optical wave guide.

The “first measuring beam” is in particular generated due to a vibration of the vibration element causing a Doppler shift of the scanning beam. This measuring beam is reflected or dispersed by the vibration element and may be guided by the identical optical wave guide or an alternative optical wave guide away from the scanning beam. Currently, the decoupling optics of the optical wave guide may simultaneously be used as coupling optics for the measuring beam in the first corresponding alternative.

The “signal beam splitter” divides the signal beam especially into the scanning beam and the reference beam. A signal beam splitter is, for example, a semipermeable mirror, thus causing the reference beam and the scanning beam to have roughly the same intensity.

In the most simply case, the “optical sensor” is a photo diode, although position sensitive sensors such as, for example, CCDs (charge coupled device), PDSs (position sensitive device) and lateral diodes may be used.

Interferences are detected especially be “superposition” of the reference beam and the measuring beam on the sensor surface of the optical sensor.

The “Doppler shift” is a frequency/wave length shift based on the Doppler effect. The Doppler effect (more rarely referred to as Doppler Fizeau effect) is temporal compression or expansion of a signal when the distance between the emitter (e.g. optical wave guide of the scanning beam) and receiver (e.g. optical wave guide of the measuring beam) is changed during the duration of the signal—here due to the vibrations of the vibration element.

The reason is the change in propagation time. This purely kinematic effect occurs for all signals that spread with a certain speed, usually the speed of light, or the speed of sound. Since the signal spreads in a medium (water or seawater), the state of motion of the medium may in this case be considered.

The “vibration” is especially the mechanical vibration of the vibration element induced by the acoustic oscillation.

The “first liquid” comprises especially water, seawater and salt water. Especially this includes any salt and seawaters present in the waters on Earth. The sea or salt waters differ especially due to varying salinity. The waters of the Mediterranean regularly show higher salinity than the waters of the Pacific Ocean.

In another embodiment, the first signal beam and/or the first reference beam and/or the first scanning beam and/or the first measuring beam are fully or partially guided in an optical wave guide. Thus, the respective beams can be imprinted with a certain course without using complex optics.

The “optical guides”, also referred to as optical wave guides or optical guide cable, is a ready-made cable consisting of optical guides and partially with connectors or an equivalent cable to transfer light. The light is, for example, guided in fibers made of quartz glass or plastic (polymeric optical fiber). Such cables or wires are frequently also referred to as fiber-optic cable, wherein in those typically several optical wave guides are bundled, and are additionally mechanically reinforced for protection and stabilization of the individual fibers.

From a physical point of view, optical wave guides are dielectric wave guides. They may, for example, be made of concentric layers; in the center is the optical core surrounded by a shell with a somewhat lower refractive index as well as by other protective plastic layers. Depending on the application, the core has a diameter of some micrometers up to over one millimeter. The art distinguishes optical wave guides depending on the course of the refractive index between the core and the shell (level index or gradient index fibers) and the number of vibration modes capable of propagation limited by the core diameter.

Multimode fibers in which several thousand modes may propagate have a very structured beam profile. In monomode fibers with a very small core diameter only the so-called basic mode may propagate. Its intensity is approximately normally distributed in a radial direction. This optical wave guide may be either a monomode fiber or a multimode fiber.

Optical wave guides are mainly used in electrical communication engineering as a transfer medium for wire-bound communication systems. In this field, they have replaced electrical transmission to copper cables in many areas because they achieve a higher range and higher transmission rates. Here, especially optics and optoelectronics from electrical communication engineering are used, since they are easily adaptable to the conditions for hydrophones and are cost-efficient.

In order to protect the vibration element against destruction and/or to obtain optimized detection of the mechanical vibration of the vibration element, one self-resonance of the first vibration element is designed in such a way that the self-resonances (e.g. thickness-mode resonance, torsional resonance, structural resonance) are outside a measuring range.

A “self-resonance”, also referred to as natural frequency, of a resonating system (here the vibration element) is a frequency with which the system may vibrate in eigenmode after a single initial excitation.

If vibrations are forced on such a system from outside, and those vibrations correspond to the self-resonance, the system in case of low absorption, reacts with particularly high amplitudes, which is referred to as resonance.

The “measuring range” is determined by a mechanical minimum frequency and a mechanical maximum frequency, which is determined by a minimum frequency and a maximum frequency of the sound to be measured. This may be the entire sound range to be expected, or sound range bands. In a towed array sonar, for example, the low underwater sound frequencies are often interesting (typically 10 Hz to 2.4 kHz, but also an extended range up to 20 kHz and more is interesting). For a bow or stern sonar, they may be higher frequencies as well (e.g. 10 kHz to 600 kHz for intercept applications).

In another embodiment, the first vibration element is acoustically transparent.

“Acoustical transparency” applies in particular if the sound upstream of the vibration element and downstream of the vibration element in case of a sound signal passage through the vibration element surrounded by the medium (seawater) is mainly identical (largely no relevant reflection and absorption of acoustic energy). Acoustical transparency also applies if the sound signal at the position of the vibration element in an arrangement is mainly identical to an arrangement without the vibration element. A characteristic transmission coefficient of the vibration element used is typically 0.99 in the spectral measuring range.

In order to protect the vibration element from the first liquid, the first vibration element may be encapsulated by a protection medium, especially a second liquid. This is particularly advantageous since sea or saltwater may present a chemically aggressive environment for the vibration element. Biological depositions of algae or mussels on the vibration element can also be avoided.

The “encapsulation” may, for example, take the form of a cage that houses the vibration element and that features slits, for instance, for letting the sound pass. In order to avoid any outflow of the second liquid, the cage may be enclosed by a protective membrane, which is in turn acoustically transparent. The protective membrane may, for example, be a thin rubber membrane.

The protective medium may be either a gas or a liquid. The gases used are mainly inert gases such as nitrogen or noble gases.

The “second liquid” has similar physical characteristics especially with regard to sound propagation as the sea or saltwater (especially the same characteristic sound impedance, corresponds to the density multiplied with the sound propagation velocity). Oils such as paraffin oil have proven to be particularly advantageous.

(In another embodiment, the first vibration element is a hollow body, especially a hollow sphere, with an enclosed hollow body). This allows the provision of a hydrophone that is based on the fact that the sound signal is physically determined by evaluating the sound pressure, or that the mechanical movement of the vibration element mainly reacts to sound alternating pressure and in a negligible way to sound velocity. In this embodiment, the liquid may also be a gas (e.g. air). This allows the provision of a “normal” acoustical microphone.

Furthermore, a sound converter may be provided that has improved characteristics with regard to dynamics and sensitivity compared to microphones in air.

A “hollow body” is generally a body featuring a hollow space that it encloses. One of the wall thicknesses of one wall of the body is designed in such a way that the sound pressure causes a change in position of the body's walls towards each other.

It may furthermore be particularly advantageous if one diameter of the hollow body is much smaller than the wave length of the largest frequency to be measured.

The hollow body may be a cuboid or cube, with the preferred hollow body having a spherical form.

The “hollow space” has in particular a lower density than the medium surrounding the wall of the hollow body. The material of the hollow body has in particular the characteristic sound impedance of the surrounding medium (e.g. saltwater), thus allowing ensured ideal sound transmission characteristics. In order to maximize the pressure on the boundary surface, the hollow body may be executed with high acoustic impedance.

In one respective embodiment, the hollow body features a medium that is compressible by (sound) pressure. The medium may, for example, be air or an inert gas. The hollow space may also be evacuated, so that the medium then is a gas with a particularly low (partial) pressure.

The “pressure compressible medium” ensures especially sufficient change in position for the wall of the body.

In order to provide a vibration element with a particularly simple structure, the first vibration element is a membrane.

A “membrane”, also referred to as vibration membrane or oscillation membrane is generally a thin skin or foil that is meant to generate, modify and/or reproduce vibrations.

The membrane may, for example, be made especially of silicon by means of etching.

Each membrane may have several self-resonances (partial vibrations), which are, however, frequently strongly absorbed. The membrane may be stretched across a firm frame (support), analogous to a drum. Alternatively, the edge of the membrane may also vibrate freely, e.g. like in an acoustic loudspeaker. Both versions are very clearly different with regard to possible modes and frequencies. It may be particularly advantageous if the membrane is supported as stress-free as possible.

Generally, the membrane may serve to generate, amplify, receive, absorb or measure the vibration. An excitation to membrane vibrations presupposes that a dynamically acting external power (here by means of the underwater sound) exists and which results, for example, from the tensile stress due to an edge clamping.

A frequency-dependent correction value may be determined for a membrane, if, for example, the mass of the membrane cannot be regarded as negligible.

In order to query several vibration elements simultaneously and provide a cost-efficient light source, the light source is a broadband laser light source as it is used, for example, in optical electrical communications technology.

The “broadband light source” consists of a doped special glass fiber, for example, which in turn is optically pumped with a powerful diode laser. Such concepts are used for fiber amplifiers and are basically very suited for generating spectrally broadband super-luminescence radiation. The preferred emission in the spectral range is around 1.5 μm, since this allows standard fiber components (plugs and connectors) to be used. Super-luminescence diodes (SLEDs) may also be used, but the pumped special optical fiber has the advantage that the broadband radiation is directly generated in the fiber in order to minimize coupling loss and adjust the emission range by suitable doping of the fiber material.

Especially in order to provide coherent light of an individual wave length for each vibration element, the scanning beam may be filtered or be guided through a filter, especially a fiber Bragg grating filter.

The “filter” is in particular an optical interference filter. The fiber Bragg gratings have the advantage that they may already be impressed onto the optical wave guide. This impressing may occur, for example, by means of femtosecond lasers.

In another aspect of the invention, the task is solved by an acoustic converter system featuring an acoustic converter according to one of the previous claims, with a second and/or third scanning beam and a second and/or third measuring beam, wherein the measuring beams are arranged in such a way that the measuring beams form an angle or a solid angle.

This allows particularly advantageously the determination of a spatial and/or directional information from the underwater sound. In this way, the direction of a sound-emitting source may be determined.

The “acoustic converter system” may also be referred to as spatial hydrophone, also referred to as a vector sensor.

By means of the “second/third scanning beam”, a different position of the vibration element or a differently oriented vibration element may be scanned.

The “second/third measuring beam” is consequently the measuring beam assigned to the second/third scanning beam.

The “spatial angle” is the opening angle at which the surrounding area is tapped. The spatial angle especially results from the fact that scanned vibration elements of the vibration element or the vibration elements have an angle to one another.

The simplest realization is by means of three surface membranes, offset against each other by 90°, each impinged with a scanning beam and each emitting a measuring beam.

The vibration element may be designed as a cube with three sides with individual vibration elements and three “open” laser passage surfaces whose side surfaces are in orthogonal position to one another and are measured with oscillation technology.

According to an additional aspect of the invention, the task is completed by an acoustic converter array featuring at least one acoustic converter system described above and/or at least one acoustic converter described above. In such an array, the distance to a sound-emitting object may additionally be determined, e.g. by triangulation.

Such an “acoustic converter array” may also be referred to as hydrophone array. It may, for example, be used for synthetic aperture sonars.

The task is furthermore solved by an optical hydrophone with an optically inferometrically scanned vibration element and an evaluation sensor.

In another aspect of the invention, the task is solved by a sonar featuring an optical hydrophone as described above and/or an acoustic converter array as described above and/or an acoustic converter system as described above and/or an acoustic converter as described above.

A “sonar” is a “device to locate items in space and under water by means of emitted sound pulses.” The word is the English acronym for sound navigation and ranging.

Sonar measuring technologies make use of the fact that sound travels at much lower loss especially at high frequencies underwater compared to in the air. For historical reasons there is a difference in terminology between sonar devices (briefly referred to as “sonars”), which mainly locate items horizontally, and depth sounders that mainly locate items vertically.

Sound signals may be used for echo ranging (active sonar, this includes depth sounders) or for the localization of objects that themselves emit sound.

Active sonars apply the echo principle and hence emit a signal themselves whose echo they receive, from which they determine the distance on the basis of the delay time of the echo. Depth sounders are of this type.

In an additional aspect of the invention, the task is solved by a watercraft, especially a ship or submarine, featuring a sonar as described above and/or an optical hydrophone as described above and/or an acoustic converter array as described above and/or an acoustic converter system as described above and/or an acoustic converter as described above.

“Watercraft” include all vessels that may move manned or unmanned on or under water or that are located on or under water. Accordingly, ships, torpedoes, buoys, submarines, AUVs (autonomous underwater vehicle) and ROVs (remotely operated vehicle) are to be regarded as submarine vessels in this context.

The invention is in the following described on the basis of embodiments. They show:

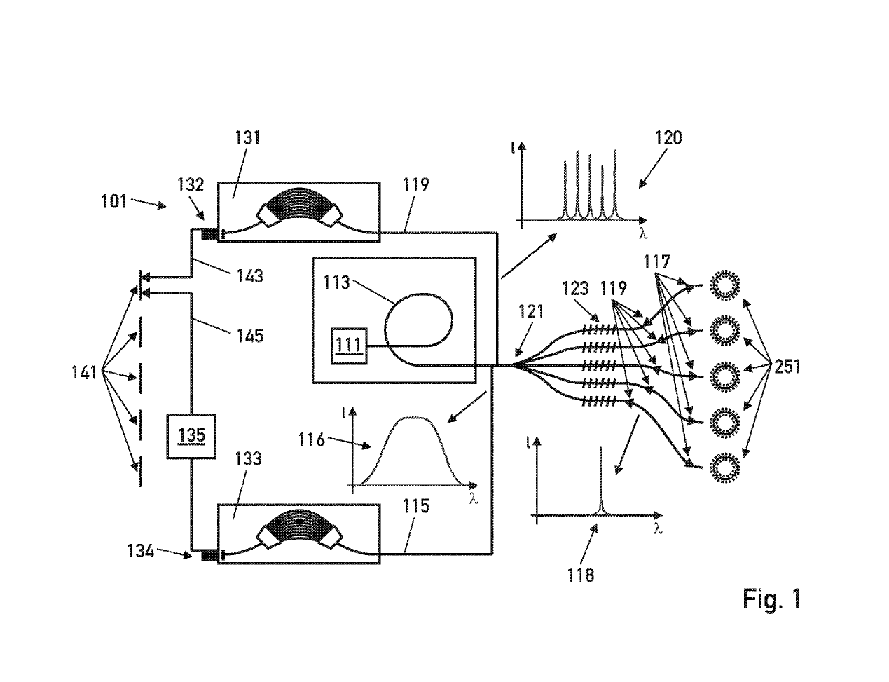

FIG. 1 a schematic representation of a microphone that determines a sound pressure on a hollow sphere and

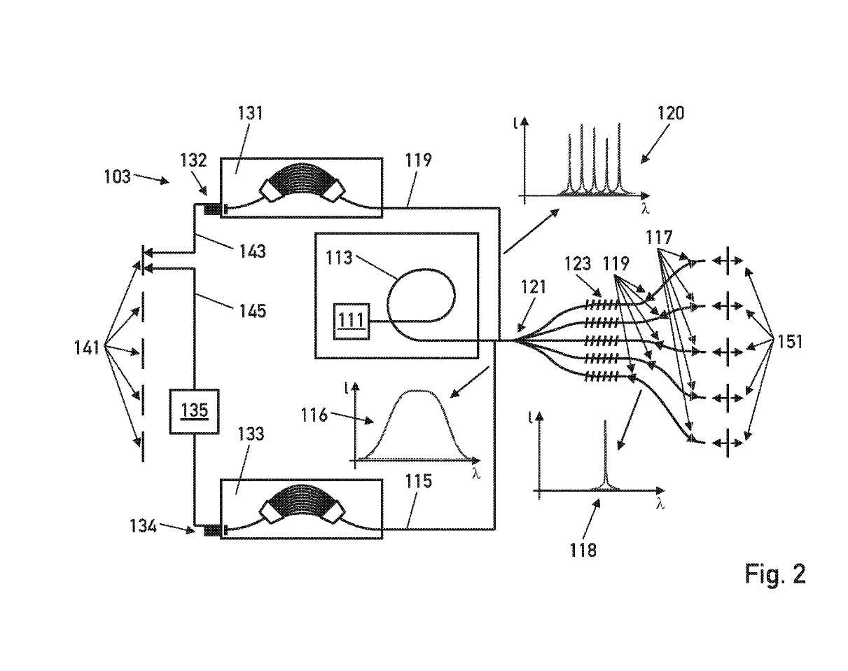

FIG. 2 a schematic representation of a hydrophone that evaluates the sound velocity of a membrane immersed in water.

A microphone 101 shows a broadband light source 111. The light source 111 emits the signal beam 113. The signal beam 113 is guided onto a semi-permeable mirror (not shown) by means of an optical wave guide. This semi-permeable mirror divides the signal beam 113 into a reference beam 115 and a scanning beam 117.

The reference beam 115 is guided by means of an optical wave guide. The spectrum 116 of the reference beam 115 corresponds to the spectrum of the light source 111 with the intensity (ordinate) approximately reduced by half.

The reference beam 117 is also guided by means of an optical wave guide 121. The optical wave guide 121 is divided into five optical wave guides that are directed onto a surface of the evacuated hollow spheres 251.

A fiber Bragg grating 123 is impressed onto the optical wave guide of one of the five scanning beams 117. The respective fiber Bragg gratings 123 are slightly different, thus shifting the respective spectrum 118 of the scanning beam 117 in wave length A.

At the end of the optical wave guide of the scanning beam 117 there are decoupling optics (not shown). These decoupling optics focus the respective scanning beam 117 onto the surface of the respective hollow sphere 251.

The hollow space of the hollow sphere 251 is evacuated and the medium between the decoupling electronics of the optical wave guide of the scanning beam 117 and the hollow sphere 251 is air.

The hollow spheres 251 are designed with a reflection, ensuring that upstream for measuring beam 119, the same optical wave guide is used as for the scanning beam 117, with the present decoupling optics also serving as coupling optics. The signal reflected on the hollow spheres 251 is guided back into the optical wave guide via the coupling optics (collection lens).

The individual measuring beams 119 are united on an optical wave guide and guided to the arrayed waveguide grating (AWG) 131 as measuring beam 119. Uniting the individual measuring beams 119 results in the spectrum 120.

The AWG 131 on the other hand divides the signal of the united measuring beam 119 into individual signals, so that separated detector measuring beams are present in the measuring fiber bundle 132 at the outlet of the AWG 131.

Each individual fiber of the measuring fiber bundle 132 is guided to the respective detector 141. The detector measuring beam 143 is guided in each of those individually directed fibers.

The procedure for the reference beam 115 is analogous. It is also guided onto an AWG 133, which once again divides the individual signals in one reference fiber bundle 134. Each of those fibers is in turn guided through a Bragg cell 135 and led to the respective photo detector 141 as a detector reference beam 145.

The detector reference beam 145 and the detector measuring beam 143 are optically superimposed on the photo detector 141.

Determining a sound signal occurs as follows:

If an airborne sound signal arrives at the hollow sphere 251 in the arrangement described, the pressure share of the sound signal causes a compression of the hollow sphere 251. This compression leads to a Doppler shift of the scanning beam 117 according to the mechanical vibration of the hollow sphere 251.

This Doppler-influenced signal is guided as the measuring beam 119 via the optical wave guide 121 to the AWG 131 as a (total) measuring beam 119 for each individual hollow sphere 251. The individual detector measuring beams 143 separated by the AWG 131 are superimposed on the respective photo detector 141 with the respective detector reference beam 145.

Due to the Doppler shift, the signal on the photo detector 141 changes according to the mechanical vibration signal of the hollow sphere 251. Accordingly, the relevant sound signal for each individual hollow sphere 251 can be determined and then processed.

The arrangement described here may also occur in such a way that the hollow sphere 251 is immersed in seawater.

The hydrophone 103 according to FIG. 2 may also be used in seawater. Here, a membrane 151 is used instead of a hollow sphere 251. The measuring process is analogous to that in FIG. 1, with in this case the sound velocity of the sound being determined instead of the sound pressure.

### LIST OF REFERENCE SYMBOLS

101 Microphone
103 Hydrophone
111 Light source
113 Signal beam
115 Reference beam
116 Reference beam spectrum
117 Scanning beam
118 Scanning beam spectrum
119 Measuring beam
120 Spectrum for all measuring beams
121 Optical wave guide
123 Fiber Bragg grating
131 Arrayed waveguide gratings (AWG) of measuring beam 119
132 Measuring fiber bunch at outlet of AWG 131
133 Arrayed waveguide gratings (AWG) of reference beam 115
134 Reference fiber bunch at outlet of AWG 133
135 Bragg cell
141 Photo detector
143 Detector measuring beam
145 Detector reference beam
151 Membrane
251 Hollow sphere

1. Acoustic converter (101), in particular a hydrophone (103), with an interferometer and an associated first vibration element (151, 251), which is maintained by a support,
wherein the interferometer comprises a light source (111), a first signal beam (113), a signal beam splitter, a first reference beam (115), a first scanning beam (117), a first measuring beam (119) and an optical sensor (141),
wherein the light source emits the first signal beam and the first reference beam and the first measuring beam are superimposed onto the optical sensor, with the first scanning beam being directed to the first vibration element,
wherein the first measuring beam causing a Doppler shift with respect to the first scanning beam based on a vibration of the first vibration element,
wherein the first vibration element is arranged in a first liquid,
wherein the first vibration element is further characterized by at least one of the following:
a self-resonance of the first vibration element is designed in such a way that the self-resonance is outside a measuring range,
the first vibration element is fully enclosed in a protective medium other than the first liquid,
the first vibration element is a hollow body (251), or
the first vibration element is a membrane (151).

2. The acoustic converter according to claim 1, wherein at least one of the first signal beam, the first reference beam, the first scanning beam, the first measuring beam are fully or is at least partially guided in an optical wave guide (121).

3. The acoustic converter according to claim 1, wherein the first vibration element having a self-resonance and having a configuration such that the self-resonance is outside a measuring range.

4. The acoustic converter according to claim 1, the first vibration element is acoustically transparent.

5. The acoustic converter according to claim 1, wherein the first vibration element is fully enclosed in a protective medium.

6. The acoustic converter according to claim 1, wherein the first vibration element is a hollow body (251).

7. The acoustic converter according to claim 6, wherein characterized in that the hollow body features a medium that is compressible by pressure.

8. The acoustic converter according to claim 1, wherein the first vibration element is a membrane (151).

9. The acoustic converter according to claim 1, wherein the light source is a broadband laser light source.

10. The acoustic converter according to claim 1, wherein the scanning beam is guided through a filter (123).

11. An acoustic apparatus comprising
(i) an acoustic converter system including an acoustic converter according to claim 1, the acoustic converter system including a second and/or third scanning beam and a second and/or third measuring beam, wherein the measuring beams are arranged in such a way that the measuring beams form an angle or a solid angle;
(ii) an acoustic converter array having at least one acoustic converter according to claim 1;
(iii) an acoustic converter array having at least one acoustic converter system having at least one converter according to claim 1 and including a second and/or third scanning beam and a second and/or third measuring beam, wherein the measuring beams are arranged in such a way that the measuring beams form an angle or a solid angle;
(iv) an optical hydrophone with an optically interferometrically scanned vibration element and an evaluation sensor;
(v) a sonar comprising at least one of
an optical hydrophone with an optically interferometrically scanned vibration element and an evaluation sensor, and
an acoustic converter array or acoustic converter system having at least one of acoustic converter according to claim 1, and optionally a second and/or third scanning beam and a second and/or third measuring beam, wherein the measuring beams are arranged in such a way that the measuring beams form an angle or a solid angle;
(vi) a watercraft comprising a ship or submarine, the watercraft having
(a) a sonar comprising at least one of
an optical hydrophone with an optically interferometrically scanned vibration element and an evaluation sensor, and
an acoustic converter array or acoustic converter system having at least one of acoustic converter according to claim 1, and optionally a second and/or third scanning beam and a second and/or third measuring beam, wherein the measuring beams are arranged in such a way that the measuring beams form an angle or a solid angle;
(b) optical hydrophone with an optically interferometrically scanned vibration element and an evaluation sensor; or
(c) an acoustic converter according to claim 1.

12. The acoustic apparatus according to claim 11, wherein the apparatus is (i) and in (i) the two or three measuring beams are emitted by the first vibration element.

13. The acoustic apparatus according to claim 11, wherein the apparatus is (ii)or (iii).

14. The acoustic apparatus according to claim 11, wherein the apparatus is (iv) the optical hydrophone with an optically interferometrically scanned vibration element and an evaluation sensor.

15. The acoustic apparatus according to claim 11, wherein the apparatus is (v).

16. The acoustic apparatus according to claim 11, wherein the apparatus is (vi).

17. The acoustic converter according to claim 1, wherein the acoustic converter
at least one of the first signal beam, the first reference beam, the first scanning beam and the first measuring beam is at least partially guided in optical wave guide (121);
the first vibration element having a self-resonance and having a configuration such that the self-resonance is outside a measuring range;
the first vibration element is acoustically transparent;
the light source is a broadband laser light source;
the scanning beam is guided through a filter (123) comprising a fiber Bragg grating filter; and
the first vibration element is a hollow body (251) or a membrane (151).
